(19) United States
(12) Patent Application Publication
(10) Pub. No.: US 2025/0100898 A1
(43) Pub. Date: Mar. 27, 2025

(54) DOUBLE-OUTLET FAUCET

(71) Applicant: Yang ZOU, Hunan Province (CN)

(72) Inventor: Yang ZOU, Hunan Province (CN)

(21) Appl. No.: 18/373,285

(22) Filed: Sep. 27, 2023

(51) Int. Cl. C02F 1/00; E03C 1/04

(52) U.S. Cl. CPC C02F 1/003; E03C 1/04; C02F 2307/06

(57) ABSTRACT

A double-outlet faucet, having a faucet body, a tap water outlet device and a purified water outlet device. The tap water outlet device is arranged on the faucet body. The purified water out device has a water purifier body connected to the faucet body, a water purifier switch valve for controlling the opening and closing of a tap water inlet of the water purifier body, and a filter element detachably fitted into a filter cavity of the water purifier body. The double-outlet faucet can output both tap water and purified water and is convenient for replacing the filter element by a user.

### BACKGROUND OF THE INVENTION

The present invention relates to the field of faucets, and in particular, to a double-outlet faucet.

The main function of a faucet is to control whether the water is discharged or not and to control the total amount of the water being discharged. In order to facilitate the use of purified water with better water quality, some of the existing faucets are provided with a filtering device, and tap water is filtered through the filtering device to become purified water with good water quality.

In many of the existing faucets provided with a filtering device, the filtering device is arranged below the faucet body. When such a faucet is mounted on a countertop, the filtering device is positioned below the countertop. However, the limited space below the countertop may lead to a troublesome filter element replacement process and thus an affected user experience.

In view of the above problems, there's a need for developing a double-outlet faucet, which can output both tap water and purified water, and is convenient for replacing the filter element by a user.

### BRIEF SUMMARY OF THE INVENTION

The present invention is intended to provide a double-outlet faucet, which can output both tap water and purified water, and is convenient for replacing the filter element by a user.

In order to achieve the above objects, the present invention adopts the following solutions:

A double-outlet faucet, comprising a faucet body, a tap water outlet device that outputs tap water, and a purified water outlet device that outputs purified water; the tap water outlet device is mounted on the faucet body; the purified water outlet device comprises a water purifier body, a water purifier switch valve, and a filter element; the water purifier body is connected to the faucet body and is positioned higher than a bottom of the faucet body; the water purifier body is provided with a filter cavity, and a tap water inlet and a purified water outlet that are in communication with the filter cavity; the filter element is detachably mounted in the filter cavity; the water purifier switch valve is mounted in the water purifier body and controls opening and closing of the tap water inlet.

The water purifier body is provided with a replacing port in communication with the filter cavity; the filter element is provided with a filter element head; the filter element head hermetically covers the replacing port and is detachably connected to the water purifier body.

The replacing port and the purified water outlet of the water purifier body are oriented perpendicular to each other; the filter element head is inserted into the replacing port and is also provided with a connecting snap fastener in snap-fit with the purified water outlet.

The connecting snap fastener has an inclined plane that facilitates removal of the connecting snap fastener from snap-fit connection with the purified water outlet; the inclined plane is slidably in cooperation with a periphery of the purified water outlet.

The water purifier switch valve comprises a water inlet seat, a water outlet seat, and a handle connected to the water outlet seat; the water inlet seat is fixedly mounted in the tap water inlet and is in hermetic fit with an inner wall of the tap water inlet; the water outlet seat is rotatably mounted in the tap water inlet and is in hermetic fit with the inner wall of the tap water inlet; the water outlet seat sleeves on the water inlet seat, and the water outlet seat is capable of being in communication with the water inlet seat by rotation of the water outlet seat; the water purifier body is provided with a slot slidably receiving the handle.

The water purifier body is rotatably connected to the faucet body.

The faucet body is provided with a mounting seat; the water purifier body is provided with a connecting sleeve rotatably sleeving the mounting seat; the connecting sleeve is in hermetic fit with the mounting seat, and an annular tap water cavity is formed between the connecting sleeve and the mounting seat; the tap water cavity is in communication with the tap water inlet of the water purifier body; the faucet body is further provided with a water flow-through seat; the water flow-through seat is provided with a tap water channel in communication with the tap water cavity.

The mounting seat is provided with a tap water flow-through port in communication with the tap water cavity; the mounting seat is connected to the water flow-through seat through a connecting assembly; the connecting assembly comprises an inner pipe, an outer pipe, and a connecting seat; the connecting seat is fixed on top of the water flow-through seat; a water flow-through cavity in communication with the tap water channel is formed between the connecting seat and the water flow-through seat; the connecting seat is provided with a water flow-through port in communication with the water flow-through cavity; upper and lower ends of the inner pipe are hermetically inserted into the mounting seat and into the connecting seat respectively; upper and lower ends of the outer pipe hermetically sleeve the mounting seat and the connecting seat respectively; a flow-through cavity in communication with the tap water flow-through port and the water flow-through port is defined by a space enclosed by the inner pipe, the outer pipe, the mounting seat, and the connecting seat.

The water flow-through seat is provided with a first water inlet, a second water inlet, a mixed water outlet and a valve mounting part; the valve mounting part is provided with a first water inlet hole, a second water inlet hole, and a mixed water outlet hole in communication with the first water inlet, the second water inlet, and the mixed water outlet respectively; a mixed water valve is mounted on the valve mounting part; the mixed water valve controls whether the mixed water outlet outputs water, as well as a flow rate and a temperature of the water output by the mixed water outlet; the mixed water outlet is connected to the tap water outlet device.

The tap water channel of the water flow-through seat is in communication with the first water inlet of the water flow-through seat.

According to the above technical solutions, the present invention has the following characteristics:

1. The double-outlet faucet of the present invention is provided with a tap water outlet device for outputting tap water and a purified water outlet device for outputting purified water, such that the double-outlet faucet can output both tap water and purified water.

2. The water purifier body of the purified water outlet device of the present invention is connected to the faucet body and is positioned higher than the bottom of the faucet body, such that when the double-outlet faucet of the present invention is mounted on a countertop, the purified water outlet device is positioned above the countertop, and the space above the countertop is convenient for a user to replace the filter element. In addition, the purified water outlet device is also provided with a water purifier switch valve for controlling the opening and closing of the tap water inlet of the water purifier body, such that the user can directly close the water inflow of the water purifier body through the water purifier switch valve before replacing the filter element, without the need of cutting off an upstream water inflow pathway when replacing the filter element, thereby facilitating the operation by the user.

### BRIEF DESCRIPTION OF THE DRAWINGS

FIG. 1 is an exploded view of the present invention.

FIG. 2 is a structural schematic view of the present invention.

FIG. 3 is a cross-sectional view of the present invention.

FIG. 4 is a second cross-sectional view of the present invention.

FIG. 5 is a first structural schematic view of the water flow-through seat according to the present invention.

FIG. 6 is a second structural schematic view of the water flow-through seat according to the present invention.

FIG. 7 is a third structural schematic view of the water flow-through seat according to the present invention.

FIG. 8 is a sectional view of the water flow-through seat according to the present invention.

### DESCRIPTION OF REFERENCE NUMERALS

faucet body 1, mounting cylinder 11,
tap water outlet device 2, pull-out faucet head 21,
purified water outlet device 3, water purifier body 31, filter cavity 311, tap water inlet 312, purified water outlet 313, replacing port 314, slot 315, connecting sleeve 316, water purifier switch valve 32, water inlet seat 321, water outlet seat 322, handle 323, filter element 33, filter element head 331, connecting snap fastener 3311, inclined plane 33111, purified water outlet nozzle 34,
mounting seat 4, tap water flow-through port 41,
water flow-through seat 5, tap water channel 51, first water inlet 52, second water inlet 53, mixed water outlet 54, valve mounting part 55, first water inlet hole 551, second water inlet hole 552, mixed water outlet hole 553, pull-out pipe hole 56,
connecting assembly 6, inner pipe 61, outer pipe 62, connecting seat 63, connecting seat body 631, water flow-through port 6311, connecting cover 632, mixed water valve 7,
bent tube 8,
tap water cavity S1, water flow-through cavity S2, flow-through cavity S3.

### DETAILED DESCRIPTION OF THE INVENTION

In order to further explain the technical solutions of the present invention, the present invention will be explained in detail by the specific embodiments.

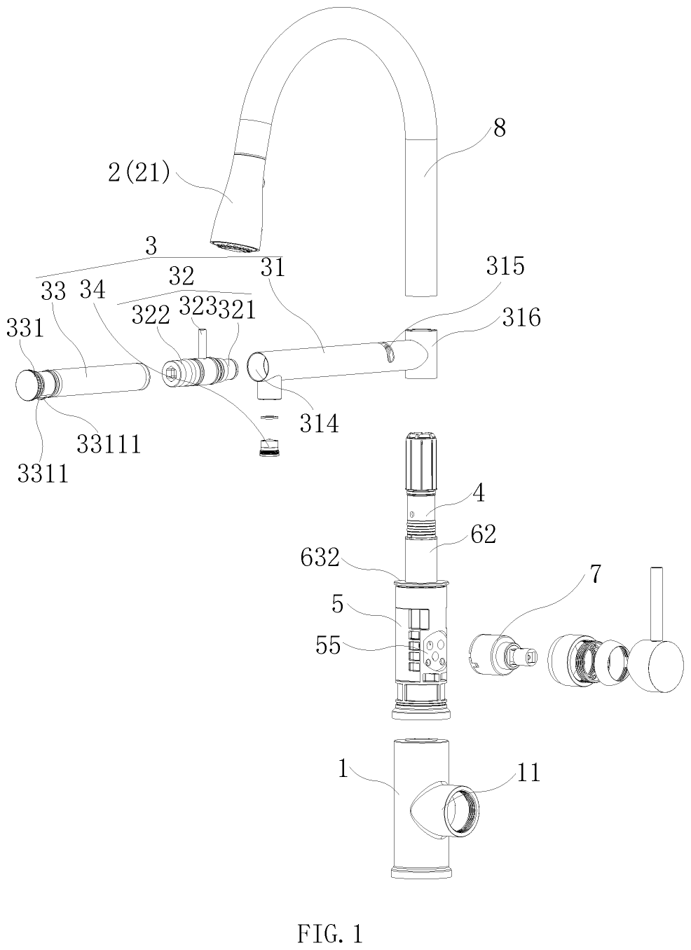

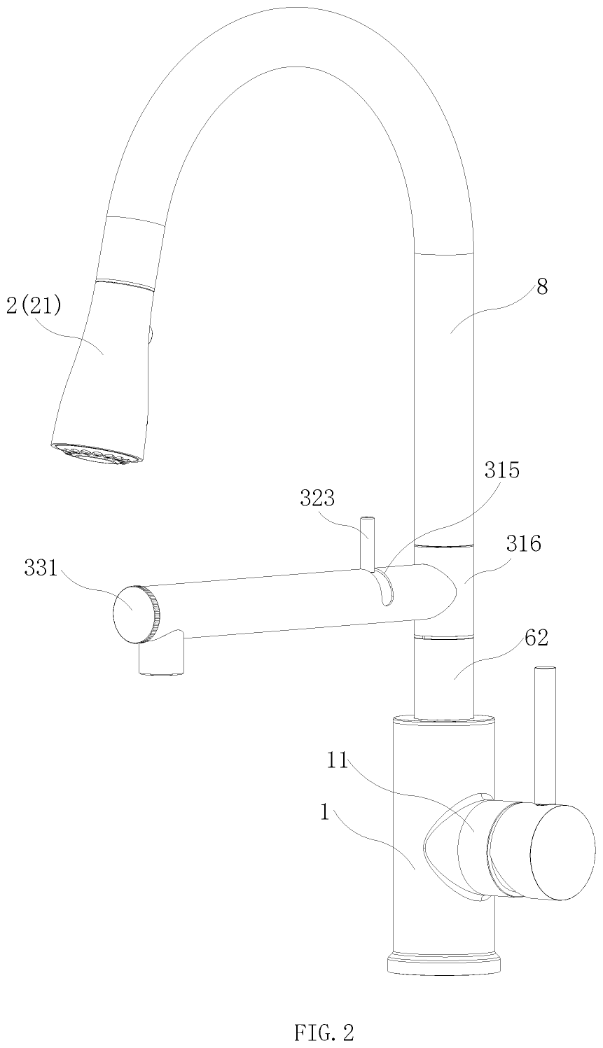

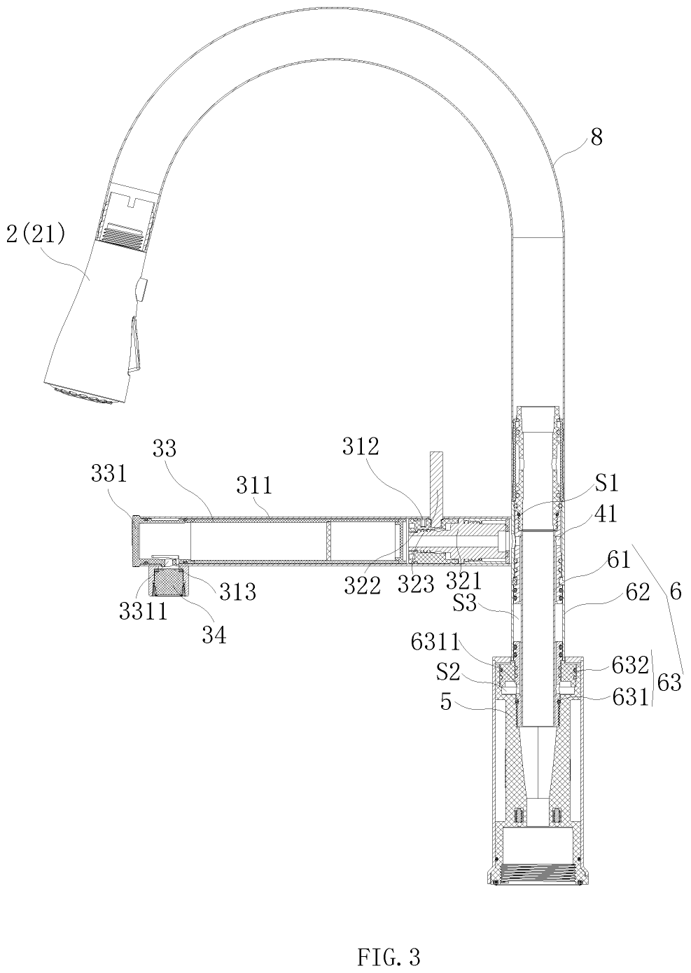

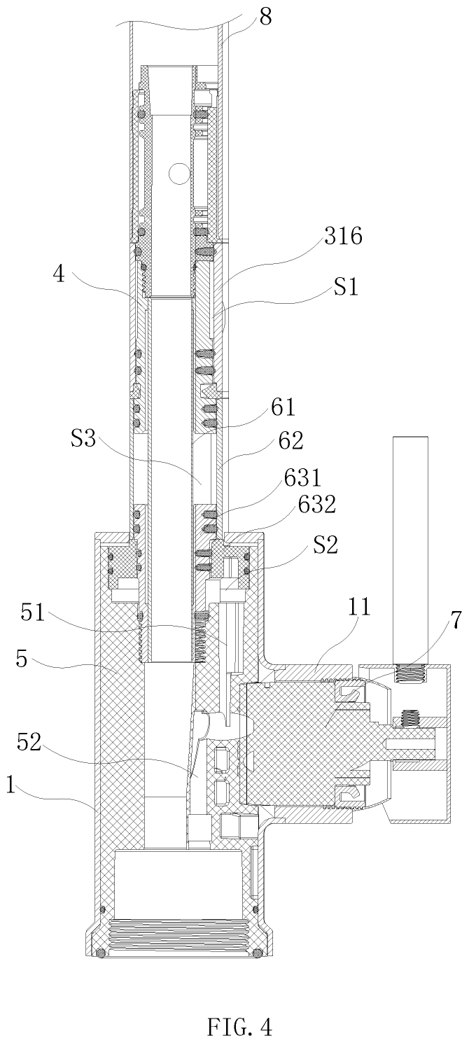

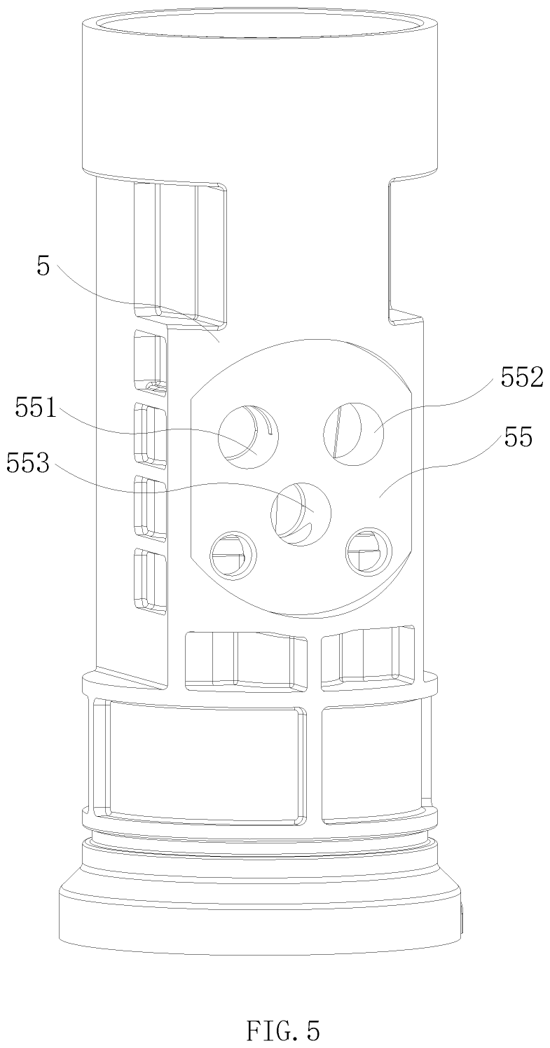

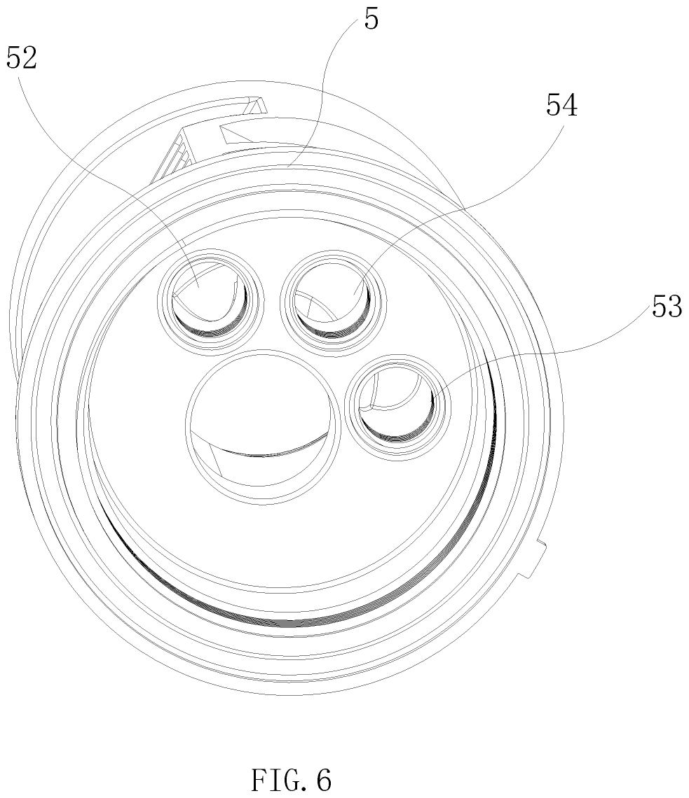

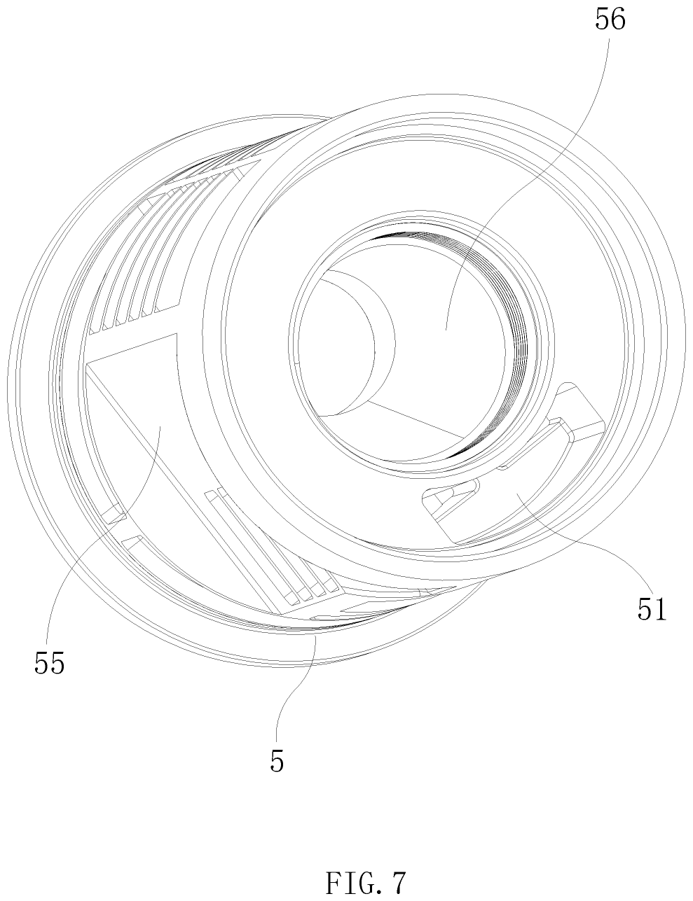

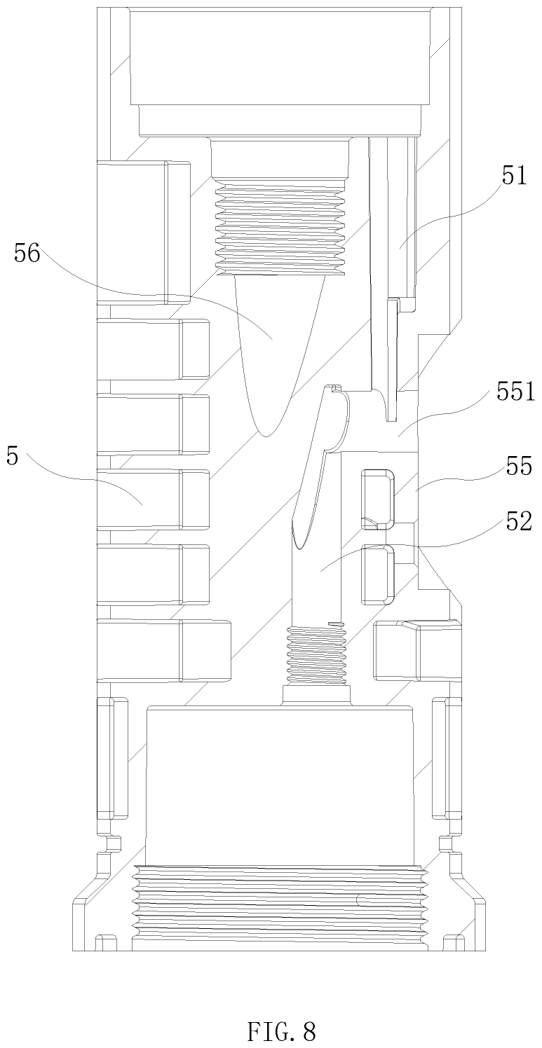

As shown in FIGS. 1 to 8, the present invention discloses a double-outlet faucet, comprising a faucet body 1, a tap water outlet device 2 for outputting tap water, and a purified water outlet device 3 for outputting purified water. The tap water outlet device 2 is mounted on the faucet body 1. The purified water outlet device 3 comprises a water purifier body 31, a water purifier switch valve 32, and a filter element 33. The water purifier body 31 is connected to the faucet body 1 and is positioned higher than a bottom of the faucet body 1. The water purifier body 31 is provided with a filter cavity 311, and a tap water inlet 312 and a purified water outlet 313 that are in communication with the filter cavity 311. The purified water outlet 313 is fitted with a purified water outlet nozzle 34 (such as a bubbler). The filter element 33 is detachably mounted in the filter cavity 311. The water purifier switch valve 32 is mounted in the water purifier body 31 and controls opening and closing of the tap water inlet 312.

In the present invention, the water purifier body 31 of the purified water outlet device 3 of the present invention is connected to the faucet body 1 and is positioned higher than the bottom of the faucet body 1, such that when the double-outlet faucet of the present invention is mounted on a countertop, the purified water outlet device 3 is positioned above the countertop, and a space above the countertop facilitate a user to replace the filter element 33. In addition, the purified water outlet device 3 is also provided with the water purifier switch valve 32 for controlling the opening and closing of the tap water inlet 312 of the water purifier body 31, such that user can directly stop water entering to the water purifier body 31 through the water purifier switch valve 32 before replacing the filter element 33, without any need for cutting off an upstream water inflow pathway (e.g., by operating an angle valve) when replacing the filter element 33, thereby facilitating operation by the user.

In an embodiment of the present invention, the water purifier body 31 is provided with a replacing port 314 in communication with the filter cavity 311. The filter element 33 is provided with a filter element head. The filter element head 331 hermetically covers the replacing port 314 and is detachably connected to the water purifier body 31, such that the user can remove the filter element 33 by simply disconnecting the filter element head 331 from the water purifier body 31, thereby facilitating the user to replace the filter element 33. The replacing port 314 and the purified water outlet 313 of the water purifier body 31 can be oriented perpendicular to each other. The filter element head 331 is inserted into the replacing port 314 and is provided with a connecting snap fastener 3311 in snap-fit with the purified water outlet 313. Such an arrangement makes the filter element head 331 in detachable connection with the water purifier body 31 through the snap-fit, thus making the dismounting of filter element head 331 from the water purifier body 31 very simple and convenient. The connecting snap fastener 3311 may have an inclined plane 33111 that facilitates removal of the connecting snap fastener 3311; the inclined plane is slidably in cooperation with a periphery of the purified water outlet 313. Specifically, the inclined plane 33111 is disposed on one side of the connecting snap fastener 3311; the inclined plane 33111 is inclined such that a distance between the inclined plane 33111 and a center of rotation of the filter element head 331 gradually increases from one side of the inclined plane 33111 towards another side of the inclined plane 33111; when the connecting snap fastener 3311 is in snap-fit with the purified water outlet 313, the user may rotate the filter element head 331 such that the inclined plane 33111 slidably coordinates with the purified water outlet 313 in a way that the inclined plane 33111 slides over the periphery of the purified water outlet 313 from said one side of the inclined plane 33111 towards said another side of the inclined plane 33111; as a result, the connection snap fastener 3311 is being pressed inwardly to reduce its diameter, such that the connecting snap fastener 3311 can be disengaged from the snap-fit connection with the purified water outlet 313. As such, the connecting snap fastener 3311 and the purified water outlet 313 can be disengaged from the snap-fit connection by rotating the filter element head 331, and this operation is easy and convenient.

In an embodiment of the present invention, the water purifier switch valve 32 comprises a water inlet seat 321, a water outlet seat 322, and a handle 323 connected to the water outlet seat 322. The water inlet seat 321 is fixedly mounted in the tap water inlet 312 and is in hermetic fit with an inner wall of the tap water inlet 312. The water outlet seat 322 is rotatably mounted in the tap water inlet 312 and is in hermetic fit with the inner wall of the tap water inlet 312. The water outlet seat 322 sleeves on the water inlet seat 321, and the water outlet seat 322 is capable of being in communication with the water inlet seat 321 by rotation of the water outlet seat 322. The water purifier body 31 is provided with a slot 315 slidably receiving the handle 323. The user may rotate the water outlet seat 322 by operating the handle 323 to control whether the water outlet seat 322 is in communication with the water inlet seat 321. The tap water inlet 312 is open when the water outlet seat 322 is in communication with the water inlet seat 321, and the tap water inlet 312 is closed when the water outlet seat 322 is not in communication with the water inlet seat 321. The water purifier switch valve 32 may be a QD-435L switch valve sold by Kaiping Hansen Sanitary Ware Co., Ltd.

In an embodiment of the present invention, the faucet body 1 may be provided with a mounting seat 4. The water purifier body 31 is provided with a connecting sleeve 316 rotatably sleeving the mounting seat 4. The connecting sleeve 316 is in hermetic fit with the mounting seat 4, and an annular tap water cavity S1 is formed between the connecting sleeve 316 and the mounting seat 4. The tap water cavity S1 is in communication with the tap water inlet 312 of the water purifier body 31. The faucet body 1 is further provided with a water flow-through seat 5. The water flow-through seat 5 is located in the faucet body 1. The water flow-through seat 5 is provided with a tap water channel 51 in communication with the tap water cavity S1. The tap water channel 51 is used for conveying tap water to the tap water cavity S1. The present invention is such arranged to enable the water purifier body 31 to rotatably fit with the faucet body 1, such that a user can rotate the water purifier body 31 to change a water outlet position of the water purifier body 31, thus avoiding mutual interference of the water purifier body 31 and the tap water outlet device 2 that otherwise affect the use of water. In addition, the user can conveniently adjust the water outlet position of the water purifier body 31 according to different use requirements, thus featuring the advantage of flexible use.

In an embodiment of the present invention, the mounting seat 4 is provided with a tap water flow-through port 41 in communication with the tap water cavity S1. The mounting seat 4 is connected to the water flow-through seat 5 through a connecting assembly 6 such that the mounting seat 4 is fitted to the faucet body 1. The connecting assembly 6 comprises an inner pipe 61, an outer pipe 62, and a connecting seat 63. The connecting seat 63 is fixed on top of the water flow-through seat 5. The connecting seat 63 comprises a connecting seat body 631 and a connecting cover 632 connected to each other. A water flow-through cavity S2 in communication with the tap water channel 51 is formed between the connecting seat 63 and the water flow-through seat 5. The connecting seat 63 is provided with a water flow-through port 6311 in communication with the water flow-through cavity S2. Upper and lower ends of the inner pipe 61 are hermetically inserted into the mounting seat 4 and into the connecting seat 63 respectively. Upper and lower ends of the outer pipe 62 hermetically sleeve the mounting seat 4 and the connecting seat 63 respectively. A flow-through cavity S3 in communication with the tap water flow-through port 41 and the water flow-through port 6311 is defined by a space enclosed by the inner pipe 61, the outer pipe 62, the mounting seat 4, and the connecting seat 63. As such, the tap water channel 51 is in communication with the tap water cavity S1 through the water flow-through cavity S2, the water flow-through port 6311, flow-through cavity S3, and the tap water flow-through port 41.

In an embodiment of the present invention, the water flow-through seat 5 may be provided with a first water inlet 52, a second water inlet 53, a mixed water outlet 54 and a valve mounting part 55. The valve mounting part 55 is provided with a first water inlet hole 551, a second water inlet hole 552, and a mixed water outlet hole 553 in communication with the first water inlet 52, the second water inlet 53, and the mixed water outlet 54 respectively. A mixed water valve 7 is mounted on the valve mounting part 55. The mixed water valve 7 is also sleeved by a mounting cylinder 11 on one side of the faucet body 1. The mixed water valve 7 controls whether the mixed water outlet 54 outputs water, as well as a flow rate and a temperature of the water output by the mixed water outlet 54. The mixed water outlet 54 is connected to the tap water outlet device 2 such that the mixed water valve 7 can control whether the tap water outlet device 2 outputs water, as well as a flow rate and a temperature of the water output by the tap water outlet device 2. The mixed water valve 7 has the structures and functions already taught by prior arts. Therefore, details of the mixed water valve 7 will not be described in detail herein. In this embodiment, the mixed water valve 7 can be a single-handle temperature and volume control valve commonly available in the market. The tap water channel 51 of the water flow-through seat 5 is in communication with the first water inlet 52 of the water flow-through seat 5, which helps simplify the structure of the water flow-through seat 5, and only one water inlet pipeline is required to supply tap water to the tap water cavity S1 and the mixed water valve 7. Tap water refers to unfiltered water that is not filtered by the filter element 33.

In an embodiment of the present invention, the tap water outlet device 2 may be a pull-out faucet head 21. The pull-out faucet head 21 is connected to the mixed water outlet 54 of the water flow-through seat 5 through a pull-out pipe (not shown). The water flow-through seat 5 is provided with a pull-out pipe hole 56 which partially accommodate the pull-out pipe. The mounting seat 4 is connected to a bent tube 8. The pull-out pipe movably passes through the water flow-through seat 5, the inner pipe 61, and the bent tube 8. The pull-out faucet head 21 detachably abuts against the bent tube 8. The mixed water outlet 54, the first water inlet 52, and the second water inlet 53 are arranged with openings facing downwards to facilitate connection of pipelines.

It should be noted that the present invention is not limited to the above described structures to rotatably connect the water purifier body 31 to the faucet body 1; other connecting structures may be adopted to rotatably connect the water purifier body 31 to the faucet body 1. In addition, the tap water outlet device 2 is not limited to the pull-out faucet head 21, and may also be other water outlet devices (such as a bubbler, or a freely rotatable universal water outlet nozzle).

The above embodiments and drawings are not intended to limit the form and style of the product of the present invention, and any suitable changes or modifications made by those of ordinary skills in the art shall fall within the patent scope of the present invention.

What is claimed is:

1. A double-outlet faucet, comprising a faucet body, a tap water outlet device that outputs tap water, and a purified water outlet device that outputs purified water;
the tap water outlet device is mounted on the faucet body;
the purified water outlet device comprises a water purifier body, a water purifier switch valve, and a filter element; the water purifier body is connected to the faucet body and is positioned higher than a bottom of the faucet body;
the water purifier body is provided with a filter cavity, and a tap water inlet and a purified water outlet that are in communication with the filter cavity; the filter element is detachably mounted in the filter cavity; the water purifier switch valve is mounted in the water purifier body and controls opening and closing of the tap water inlet.

2. The double-outlet faucet of claim 1, wherein the water purifier body is provided with a replacing port in communication with the filter cavity; the filter element is provided with a filter element head; the filter element head hermetically covers the replacing port and is detachably connected to the water purifier body.

3. The double-outlet faucet of claim 2, wherein the replacing port and the purified water outlet of the water purifier body are oriented perpendicular to each other; the filter element head is inserted into the replacing port and is also provided with a connecting snap fastener in snap-fit with the purified water outlet.

4. The double-outlet faucet of claim 3, wherein the connecting snap fastener has an inclined plane that facilitates removal of the connecting snap fastener from snap-fit connection with the purified water outlet; the inclined plane is slidably in cooperation with a periphery of the purified water outlet.

5. The double-outlet faucet of claim 1, wherein the water purifier switch valve comprises a water inlet seat, a water outlet seat, and a handle connected to the water outlet seat; the water inlet seat is fixedly mounted in the tap water inlet and is in hermetic fit with an inner wall of the tap water inlet; the water outlet seat is rotatably mounted in the tap water inlet and is in hermetic fit with the inner wall of the tap water inlet; the water outlet seat sleeves on the water inlet seat, and the water outlet seat is capable of being in communication with the water inlet seat by rotation of the water outlet seat;
the water purifier body is provided with a slot slidably receiving the handle.

6. The double-outlet faucet of claim 1, wherein the water purifier body is rotatably connected to the faucet body.

7. The double-outlet faucet of claim 6, wherein the faucet body is provided with a mounting seat; the water purifier body is provided with a connecting sleeve rotatably sleeving the mounting seat; the connecting sleeve is in hermetic fit with the mounting seat, and an annular tap water cavity is formed between the connecting sleeve and the mounting seat; the tap water cavity is in communication with the tap water inlet of the water purifier body;
the faucet body is further provided with a water flow-through seat; the water flow-through seat is provided with a tap water channel in communication with the tap water cavity.

8. The double-outlet faucet of claim 7, wherein the mounting seat is provided with a tap water flow-through port in communication with the tap water cavity;
the mounting seat is connected to the water flow-through seat through a connecting assembly;
the connecting assembly comprises an inner pipe, an outer pipe, and a connecting seat; the connecting seat is fixed on top of the water flow-through seat; a water flow-through cavity in communication with the tap water channel is formed between the connecting seat and the water flow-through seat; the connecting seat is provided with a water flow-through port in communication with the water flow-through cavity; upper and lower ends of the inner pipe are hermetically inserted into the mounting seat and into the connecting seat respectively; upper and lower ends of the outer pipe hermetically sleeve the mounting seat and the connecting seat respectively; a flow-through cavity in communication with the tap water flow-through port and the water flow-through port is defined by a space enclosed by the inner pipe, the outer pipe, the mounting seat, and the connecting seat.

9. The double-outlet faucet of claim 7, wherein the water flow-through seat is provided with a first water inlet, a second water inlet, a mixed water outlet and a valve mounting part; the valve mounting part is provided with a first water inlet hole, a second water inlet hole, and a mixed water outlet hole in communication with the first water inlet, the second water inlet, and the mixed water outlet respectively; a mixed water valve is mounted on the valve mounting part; the mixed water valve controls whether the mixed water outlet outputs water, as well as a flow rate and a temperature of the water output by the mixed water outlet; the mixed water outlet is connected to the tap water outlet device.

10. The double-outlet faucet of claim 9, wherein the tap water channel of the water flow-through seat is in communication with the first water inlet of the water flow-through seat.
